(19) United States
(12) Patent Application Publication
(10) Pub. No.: US 2007/0266626 A1
(43) Pub. Date: Nov. 22, 2007

(54) Root barrier

(76) Inventor: Bill Dworzan, Santa Ana, CA (US)

Correspondence Address: LAW OFFICES OF CLEMENT CHENG, 17220 NEWHOPE STREET #127, FOUNTAIN VALLEY, CA, 92708, US

(21) Appl. No.: 11/435,834

(22) Filed: May 16, 2006

(51) Int. Cl. A01G 13/02

(52) U.S. Cl. 47/32.7

(57) ABSTRACT

A root barrier for guiding the growth of tree roots is comprised of many distinct developments. The elongated sheet of flexible material has a top horizontal edge, a bottom edge parallel to the top edge, an internal plane and an external plane, and multiple vertical folds extending across the elongated sheet from the top edge to bottom edge. The folds are aligned parallel to one another along the length of the sheet, and each includes two vertical walls connected by a third wall, establishing a distal U-bend or corrugation. The elongated sheet can be sized by scoring, then cutting or snapping one of the bends of the folds. This will result in the corrugations on opposite ends of the sheet fitting tightly within one another, creating a hold that effectively replaces the traditional clip function.

### CROSS REFERENCE TO RELATED APPLICATIONS

Smith U.S. Pat. No. 5,477,639

Smith U.S. Pat. No. 5,615,517

### BACKGROUND OF THE INVENTION

A. Field of the Invention

Technology proposed in the following utility patent yields an innovation within the field of landscaping. The present invention relates to a landscape barrier. More particularly, the present invention relates to a barrier panel that functions to control outgrowth of tree roots, as well as provide a labor efficient alternative to designs currently on the market.

B. Description of the Prior Art

Various types of tree root barriers are prevalent within the landscape industry. One particular design consists of a ribbed panel that is circumferentially adjusted to fit tightly around the roots of a tree. Prior art for this configuration shows panel ribs as several parallel vertical protrusions that stem from an angled plane within the panel. An edge connector joins the ribs to complete the device. As roots begin to grow beyond the desired base circumference, the ribs downwardly deflect the direction of growth. By preventing the potential for horizontal expansion, the tree root barrier serves as a safeguard against many public health hazards associated with unrestrained root growth.

Several unique designs depict potential combinations of the deflector ribs and edge connectors which comprise a typical tree root barrier.

U.S. Pat. No. 4,995,191 to Davis discloses a root barrier comprised of an array of modular bent panels, wherein internal and external ribs lie on the lateral edges of the panels. Though seemingly capable, this design proves inefficient during the installation process. The adjacent edge ribs must be initially fastened with three or more separate connectors to create an annular root barrier of complementary size to each individual tree.

Smith provided a root barrier in U.S. Pat. No. 5,477,639 and U.S. Pat. No. 5,615,517, the disclosures of which are incorporated herein by reference. References to these patents exhibit a root barrier envelope composed of a single panel. The lateral edges of apparatus are connected by a complementarily aligned end closure element, forming an annular envelope around the tree. This design is problematic because the size of the barrier is predetermined at the time of manufacture, thus not adaptable to various circumferential tree measurements.

U.S. Design Pat. No. D352,871 to Miller et al., the disclosure of which is incorporated herein by reference, shows a root barrier panel having vertical ribs on a flat surface and lateral edges terminated by in-line connector elements. Miller shows yet another variation of the root barrier panel. Its vertical ribs lie on a flat surface, and its lateral edges are terminated by aligned connector elements. This design allows for multiple panels to be connected in series as well as annular form.

Waterproof sealant tape is commonly used to mold a barrier sheet into a collar. Various types of resin have become the material of choice for contemporary root barriers as opposed to the traditional root barriers fabricated from sheet metals.

The field application of the modular root barrier and root envelope is most efficient during seeding or after root pruning of a tree. It functions by the installation of additional barrier sheets. When tending to street curbs or sidewalks, the prior art is less practical. This is due to the apparatus' predetermined circumferential length, and/or numerous connectors that require extensive labor to size.

Another noteworthy drawback of existing barriers is an inherent weakness at the connection line. Connectors in prior art require a clip to hold the opposite edges of the barrier panels even with one another. As outward growth of roots begins to press against the panels, the connection of the clips weakens. Such lack of a secure hold will ultimately result in the disintegration of the barrier.

The objective of the present invention is threefold. First, manufacture is comparatively simple. Second, its components are integrated into a root barrier roll sheet that contains everything necessary to establish a fully functional root barrier without additional connector pieces or specialized skill. Third, the need for manual labor is minimized because opposite ends of the barrier panel do not need to be cut or connected.

### SUMMARY OF THE INVENTION

A root barrier for guiding the growth of tree roots according to the present invention is comprised of many distinct developments. A continuous barrier sheet can be unrolled, deploying its transverse ribs or vanes as well as its deflector ribs which interlock with one another. This eliminates the need for separate connector parts. The elongated sheet of flexible material has a top horizontal edge, a bottom edge parallel to the top edge, an internal plane and an external plane, and multiple vertical folds extending across the elongated sheet from the top edge to bottom edge. The folds are aligned parallel to one another along the length of the sheet, and each includes two vertical walls connected by a third wall, establishing a distal U-bend or corrugation. The elongated sheet can be sized by scoring, then cutting or snapping one of the bends of the folds. This will result in the corrugations on opposite ends of the sheet fitting tightly within one another, creating a hold that effectively replaces the traditional clip function.

In another embodiment of the present invention, one or more modular panels of flexible material can potentially interlock along their peripheries to form a rigid unit capable of lining a linear or circular planted area. The root barrier has a predetermined number of parallel root-deflecting folds that are constructed from each flat panel. Folds located at the periphery of the panels may be deformed into either a lip or a clip member, enabling the lip of one panel to lock in the adjacent clip of the next panel, thus providing panel assembly of desired length. This assembly may extend linearly along a planting area or used to encircle roots.

### BRIEF DESCRIPTION OF THE DRAWINGS

FIG. 1 is a perspective view of a root barrier installed around a tree according to the present invention.

FIG. 2 is an enlarged perspective view of a section of the root barrier of FIG. 1, which illustrates the deflector ribs made of transverse folds of the barrier material.

FIG. 3 is a top view of the root barrier of FIG. 1, which illustrates the annular formation of the barrier through a connection between the opposite end ribs.

FIG. 4 is an enlarged view of the end ribs of FIG. 3 in a locking engagement.

FIG. 5 is a depiction of the consecutive folds as they are constructed on a blank sheet as it exits an extrusion forming process.

Similar reference numbers denote corresponding features throughout the attached drawings.

### DETAILED DESCRIPTION OF THE PREFERRED EMBODIMENT

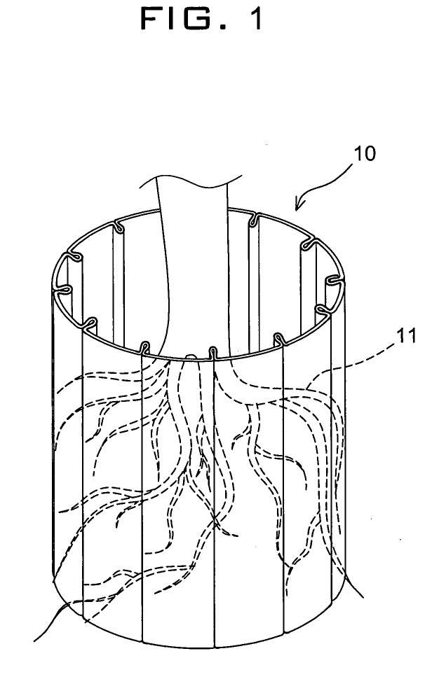

FIG. 1 shows a root barrier 10 of the present invention installed about a tree root 11. Due to its inherent flexibility, the barrier 10 can be made into a sheet of any length that can be rolled for convenient handling and transportation. Current architectural standards show root barrier thickness specifications ranging from 0.085 inches to 0.6 inches, with increased thickness yielding greater durability. The barrier sheet 10 has a constant thickness of approximately one-sixteenth of an inch. One available width of the sheet 10 is eighteen inches, but twelve, twenty-four, thirty-six and forty-eight inch sizes can also be produced without departing from the principle of the present invention. Those widths become the depth of the barrier at installation on the landscape site.

The sheet 10 has a built-in modular feature which allows for cutting and joining any combination of sheet sections to alter the diameter a root barrier 10 to fit any particular tree size.

The sheet may be cast, extruded or injection molded into any length and size desired by the client. The present invention is typically made of polyethylene, and the substitute material polystyrene can also be used. Long-lasting materials such as resin tiered graphite laminates, plastic molded and extruded materials such as PVC, polyethylene, polystyrene, and polypropylene are also suitable.

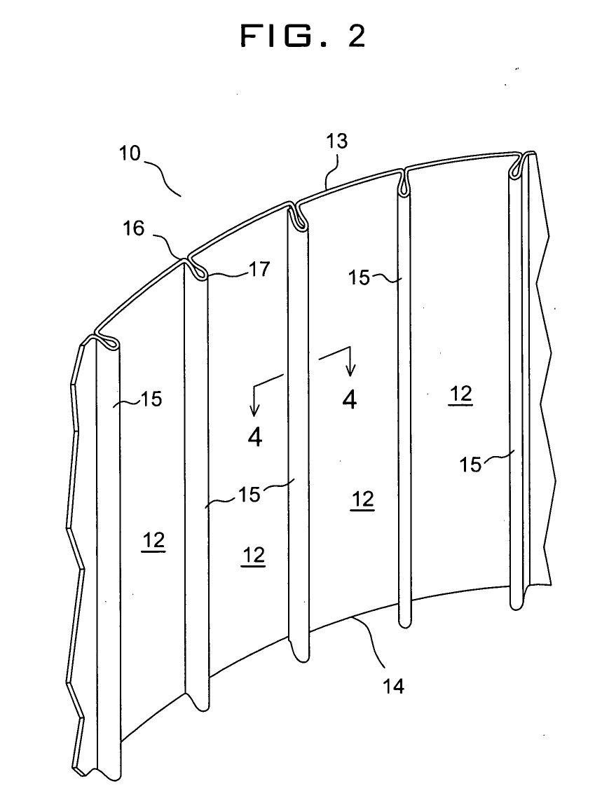

In reference to FIG. 2, the sheet consists of rectangular flat areas 12 with parallel longitudinal edges, which are referred to as a top edge 13 and a bottom edge 14 once the sheet is cut and assembled into a root barrier 10. Across the two edges 13 and 14 are vertical folds 15, which appear at an even interval throughout the length of the sheet 10. The length of the interval between the folds 15 is typically five inches, but can be altered as desired.

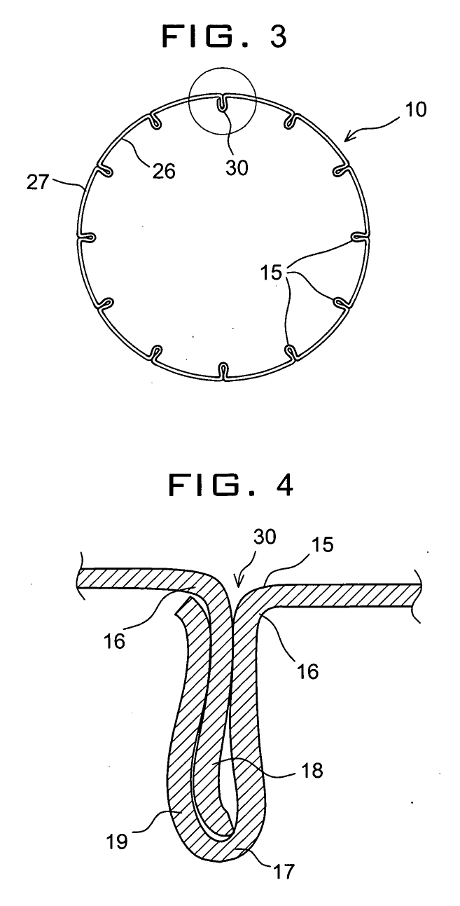

As shown in FIGS. 3 and 4, the vertical folds 15 are adapted to face the inward of the assembled root barrier 10. The folds 15 form vanes that are aligned vertically and protrude perpendicularly from the sheet. The vanes 15 redirect roots away from the inner surface of the barrier sheet 10. As roots grow toward the inside surface of the barrier, the vanes channel the roots downward to provide strength for new plantings.

Each of the vertical folds 15 includes three severing lines with two proximal perpendicular bends 16 and a distal U-bend 17 connecting the vertical walls of the folds between the proximal bends 16. This allows the sheet 10 to be snapped at the desired severing lines to create the appropriate diameter for the root barrier. An installer crosscuts or snaps the sheet at one edge, leaving an end lip 18 and at the opposite edge with an end clip 19 remaining. This consequently provides an interlocking gap 30 for closing the sheet into the root barrier 10.

Installation of the root barrier 10 is accomplished by simply wrapping the cut sheet around the tree root being planted, with the vertical folds 15 facing the root. Then the end lip 18 on the end clip 19 are superimposed and pressed toward one another all by empty hands.

The lip clip junction component is described as follows. To retain lip 19, the adjacent initial bends 16 in single fold 15 are biased to one another, while the firm nature of the sheet material serves to maintain an unyielding hold of end lip 19. The gap 30, which is typically closed at this point, provides a biasing force that secures the corner edges 16 together, acting as a clip.

Additionally, the connection between the lip 18 and clip 19 is on a perpendicular plane in respect to the circumferential barrier 10 shown in FIG. 4. Such strategic angular placement functions to maintain the integrity of annular barrier structure by adding resistance to the expansive force of a growing root.

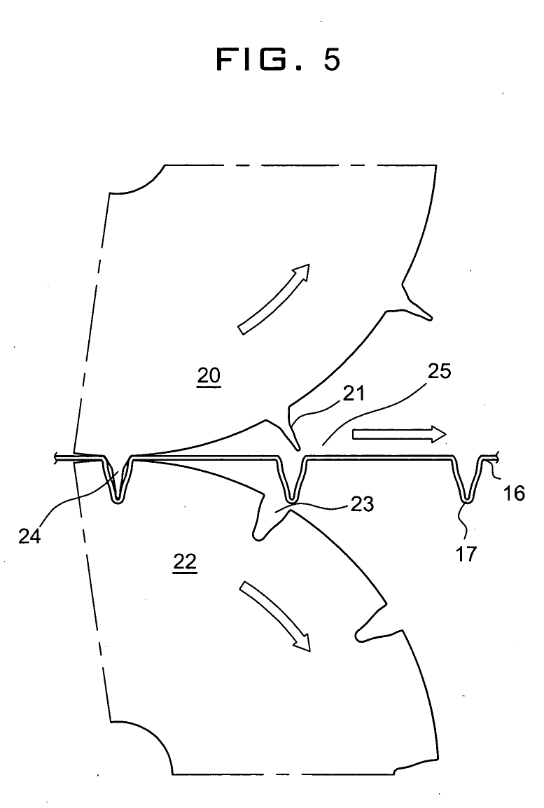

FIG. 5 provides an illustration of the typical thermal folding manufacturing process during or after the sheet is formed. It depicts the part of the procedure wherein the sheet is cured and heated, either locally or entirely, to a temperature suitable for the thermal formation of the deflector folds 15. An upper rotary die 20 with several elongated male surfaces 21 rotates counterclockwise while a lower die 22 with a complementary female surface 23 rotates simultaneously in the clockwise direction. As the sheet passes between the two rotary dies from the left of the drawing, it is formed thermally at a center station 24 and then released at an exit station 25, wherein an additional crimping means (not shown) may be used to tighten the newly formed bends 16 and 17. The hot folds 15 are then cooled, and the resulting sheet is formed into a roll, completing the process. Alternatively, the upper roller 20 and lower roller 22 can be shaped so that crimping is not necessary, enabling the gap 30 to be small or entirely closed as it exits the rollers.

It is important to note that other types of folding machines can be used to form the folds.

In an alternative design, several modular panel members may constitute the root barrier 10. Each panel member typically has about five deflector folds 15 between flat areas 12, with the folds at opposite ends snapped off into either the lip 18 or clip 19. This allows the lip 18 of one panel member to firmly lock into the adjacent clip 19 of the next panel member. In the case that a single panel member is long enough for a tree root, the lip 18 of the panel can fit into the clip 19 on the same panel. The deflector folds 15 can be manually snapped down to relatively small sections, yielding a substantially easy method of adjusting the barrier size.

The present invention is conducive to the modular panel member design. In this case, the deflector folds 15 are simultaneously molded with the flat areas 12 using a mold cavity containing the cross section of the folds 15, thus eliminating the thermal folding process illustrated in FIG. 5.

When three panels are interconnected along their lip-clip junctions, they unitarily comprise a cylindrical envelope ring that functions as the root barrier 10. The apparatus becomes rigid upon assembly, and the barrier 10 has a defined interior surface 26 and an exterior surface 27. See FIG. 3.

The panels may vary in height and profile, such that one can use various panels to form an appropriate root barrier. The presently preferred form of the root barrier has been shown, described, and several modifications thereof discussed, and persons skilled in this art will readily appreciate that various additional changes and modifications may be made without departing from the spirit of the invention, as defined and differentiated by the following claims.

It is to be understood that the present invention is not limited to the sole embodiment describe above, but encompasses any and all embodiments within the scope of the following claims.

1. A root barrier for guiding the growth of roots comprising:
a. an elongated sheet of flexible material having a top longitudinal edge, a bottom edge parallel to the top edge, an internal plane and an external plane; and
b. folds latitudinal oriented formed on the elongated sheet extending across the elongated sheet from the top edge to bottom edge, the folds being disposed parallel to each other throughout the length of the sheet, and wherein each fold includes two vertical walls joined at a U-bend protruding into the internal plane.

2. The root barrier of claim 1, wherein the elongated sheet has a joined configuration and an open configuration, wherein the joined configuration is sized by joining selected bends of the folds together.

3. The root barrier of claim 1, wherein the sheet has substantially an even thickness of about 0.8 mil.

4. The root barrier of claim 1, wherein the sheet is extruded into a prescribed size and length from the set of materials consisting of: resin tiered graphite laminates, plastic molded and extruded materials such as PVC, polyethylene, polystyrene, and polypropylene.

5. The root barrier of claim 1, wherein the sheet is joined by lip clip junction means.

6. A root barrier for guiding the growth of tree roots comprising:
a. one or more flat panels of flexible material, capable of interlocking along their peripheries to form a rigid unit capable of lining a planted area which is linear or circular, the panels defining an inner side adjacent to roots, and an outer side away from roots; and
b. a predetermined number of root-deflecting folds erected from the flat panel in parallel to each other, the folds at the periphery of the panels may be deformed into either a lip or a clip member so that the lip of one panel can be locked in the adjacent clip of the next panel to provide a desired length of panel assembly, which may extend linearly along a planting area or locked on itself through the engagement of the lip and clip members at the peripheries of the panel assembly to encircle a single root.

7. The root barrier of claim 6, wherein the panel has substantially an even thickness of about one 16th of an inch.

8. The root barrier of claim 6, wherein the panel may be cast, extruded or injection molded into a prescribed size and length from the set of materials consisting of: resin tiered graphite laminates, plastic molded and extruded materials such as PVC, polyethylene, polystyrene, and polypropylene.

9. The root barrier of claim 6, wherein the sheet is joined by lip clip junction means.

10. A method of making a root barrier for guiding the growth of tree roots comprising the steps of:
a. heating a plastic sheet;
b. passing the plastic sheet through a pair of rotary die, a first die having a plurality of elongated male surfaces spanning its breadth while a second die has a complementary female surface rotating in concert to form root-deflecting folds.

11. The method of making a root barrier of claim 10 further comprising the step of crimp tightening the bends.

12. The product made by the method of claim 10 wherein the panel is a flexible material, wherein the panel interlocks along a periphery to form a rigid unit.

13. The product made by the method of claim 10 wherein the panel is a flexible material, wherein the panel interlocks along a periphery to form a rigid unit, and wherein the a lip member locks in an adjacent clip to provide any desired length of panel assembly, which may extend linearly along a planting area.
